(19) United States
(12) Patent Application Publication
(10) Pub. No.: US 2010/0090809 A1
(43) Pub. Date: Apr. 15, 2010

(54) METHOD AND APPARATUS FOR TRANSMITTING SENSOR STATUS OF RADIO FREQUENCY IDENTIFICATION TAG

(76) Inventors: Junho Yeo, Daegu-city (KR); Preishuber-Pfluegl Josef, Klagenfurt (AT); Janek Alex, Graz (AT); Schuhai Andreas, Portschach (AT); Hae-Won Son, Daejeon-city (KR); Jae-Young Jung, Daejeon-city (KR); Gil-Young Choi, Daejeon-city (KR); Cheol-Sig Pyo, Daejeon-city (KR); Jong-Suk Chae, Daejeon-city (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/530,780

(22) PCT Filed: Jan. 21, 2008
(86) PCT No.: PCT/KR2008/000364

§ 371 Date: Nov. 12, 2009

(30) Foreign Application Priority Data
Mar. 14, 2007 (KR) 1020070025075
Nov. 30, 2007 (KR) 1020070123645

(51) Int. Cl. G06K 7/01

(52) U.S. Cl. 340/10.41

(57) ABSTRACT

Provided are a method and apparatus for transmitting a sensor status of a radio frequency identification (RFID) tag. The method and apparatus transmit an RFID tag identifier (ID) together with sensor data or sensor status information to an RFID reader, thereby enabling the RFID reader to receive the sensor status information about the RFID tag without additionally communicating with the RFID tag.

### TECHNICAL FIELD

The present invention relates to a radio frequency identification (RFID) tag, and more particularly, to a method and apparatus for transmitting a sensor status of an RFID tag and/or sensor data measured by a sensor of the RFID tag an RFID reader with an RFID tag identifier (ID) to an RFID reader.

The present invention was supported by the Information Technology (IT) Research & Development (R&D) program of the Ministry of Information and Communication (MIC) and the Institute for Information Technology Advancement (IITA), Republic of Korea. [Project No. 2005-S-106-02, Project Title: Developed technologies of a sensor tag and a sensor node for RFID/USN].

This application claims the benefit of Korean Patent Application No. 10-2007-0025075, filed on Mar. 14, 2007, and Korean Patent Application No. 10-2007-0123645, filed on Nov. 30, 2007 in the Korean Intellectual Property Office, the disclosure of which is incorporated herein in its entirety by reference.

### BACKGROUND ART

In general, radio frequency identification (RFID) technology serves to measure locations of objects, remotely process operations of the objects, manage the objects, and exchange information among the objects by attaching tags to the objects, wirelessly recognizing unique identifiers (IDs) of the objects, and gathering, storing, processing, and tracing corresponding information. Specifically, the latest RFID technology has expanded to include a function of sensing environmental information by using a sensor in addition to a function of transmitting unique identifier (ID) information.

In this case, the RFID tag requires high-speed communication in order to search for a memory location in which a sensor status record is stored. When an RFID reader desires to check a sensor status of an RFID tag after receiving the sensed value of the RFID tag, an authentication process has to be performed with respect to each sensor.

### DISCLOSURE OF INVENTION

### Technical Problem

In the conventional technology, there is a problem since it takes long time to search for the memory location in which the sensor status record is stored.

### Technical Solution

The present invention provides a method and apparatus for transmitting a sensor status of an radio frequency identification (RFID) tag, which transmit an RFID tag identifier (ID) together with sensor data and/or status information about each sensor in the RFID tag to an RFID reader, thereby enabling the RFID reader to receive the sensor data and/or status information about the RFID tag without having to additionally communicate with the RFID tag.

### ADVANTAGEOUS EFFECTS

The apparatus for transmitting the sensor status of the RFID tag according to the present invention stores the sensor data together with the sensor status information and transmits the sensor data and the sensor status information together with the UII of the RFID tag. Thus, the RFID reader can directly monitor and trace a value and a status, which are of each sensor in the RFID tag.

Accordingly, the RFID reader does not need to additionally communicate with the RFID tag so as to obtain the status information about each sensor.

### DESCRIPTION OF DRAWINGS

The above and other features and advantages of the present invention will become more apparent by describing in detail embodiments thereof with reference to the attached drawings in which:

FIG. 1 is a block diagram illustrating a configuration of a system for transmitting a sensor status of a radio frequency identification (RFID) tag according to an embodiment of the present invention;

FIG. 2 is a diagram illustrating a structure of eXtended Protocol Control (XPC) according to an embodiment of the present invention;

FIG. 3 is a diagram illustrating a structure of a memory bank (MB) in which sensor data and a sensor address map (SAM) are stored according to another embodiment of the present invention; and

FIG. 4 is a flowchart of a method of transmitting a sensor status of an RFID tag, according to an embodiment of the present invention.

### BEST MODE

According to an aspect of the present invention, there is provided an apparatus for transmitting a sensor status of an RFID (radio frequency identification) tag, the apparatus including one or more sensors sensing and measuring a physical change in an external environment; a memory storing sensor data and sensor status information which are measured by the one or more sensors; and a message generation unit generating a response message comprising an RFID tag ID (identifier), and at least one of a status record generated based on the sensor status information and the sensor data.

According to another aspect of the present invention, there is provided a method of transmitting a sensor status of an RFID tag, the method including the operations of sensing a physical change in an external environment from one or more sensors which are connected the RFID tag; storing sensor data and sensor status information measured by the one or more sensors; generating a status record based on the sensor status information about the one or more sensors; and generating a response message comprising an RFID tag ID, and at least one of the status record created based on the sensor status information and the sensor data.

According to another aspect of the present invention, there is provided a method of generating a response message with respect to a sensor data request from an RFID reader by an RFID tag, the method including the operations of recording a UII (unique item identifier) of the RFID tag; recording sensor data gathered from one or more sensors which have measured a physical change in an external item; and recording status information about each of the one or more sensors.

According to another aspect of the present invention, there is provided a computer readable recording medium having recorded thereon a program for executing the method of transmitting the sensor status of the RFID tag and the method of generating the response message including the sensor status information by using a computer.

### MODE FOR INVENTION

Hereinafter, embodiments of the present invention will be described in detail with reference to the attached drawings. Like reference numerals in the drawings denote like elements. When it is determined that the detailed descriptions of the known techniques or structures related to the present invention depart from the scope of the invention, the detailed descriptions will be omitted.

Meanwhile, when a part ‘includes’ or ‘comprises’ a component, this does not mean that the part excludes other components but means that the part may further include the other components, provided that there is no contrary mention regarding the exclusion.

Hereinafter, an apparatus for transmitting a sensor status of a radio frequency identification (RFID) tag according to an embodiment of the present invention will be described in detail.

The present invention transmits an RFID tag identifier (ID) together with sensor data or sensor status information to an RFID reader, thereby enabling the RFID reader to receive the sensor status information about the RFID tag without additionally communicating with the RFID tag.

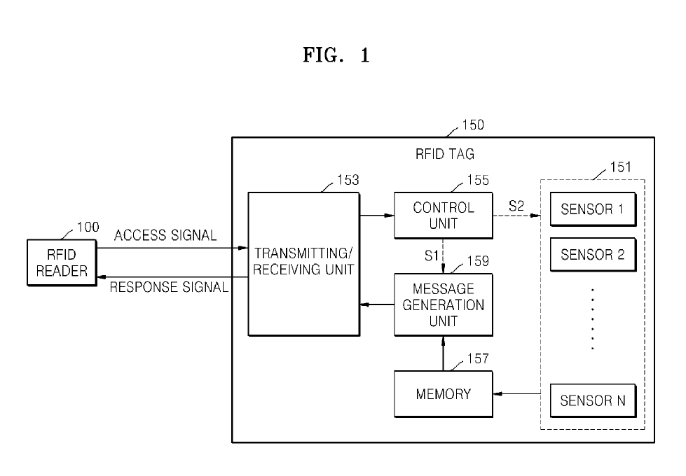

FIG. 1 is a block diagram illustrating a configuration of a system for transmitting a sensor status of an RFID tag according to an embodiment of the present invention.

Referring to FIG. 1, the system for transmitting the sensor status of the RFID tag includes an RFID reader 100 requesting sensor data, and an RFID tag 150 generating a response signal (a response message) in response to a request of the RFID reader 100.

The RFID tag 150 includes an apparatus for transmitting a sensor status, wherein the apparatus includes one or more sensors 151, a transmitting/receiving unit 153, a control unit 155, a memory 157, and a message generation unit 159.

The sensor 151 senses a physical change of an item to which the RFID tag 150 is attached, and measures a value corresponding to the physical change. The sensor 151 may be embedded in the RFID tag 150 or connected to the RFID tag 150 by using various methods. For the sensor 151, various types of sensors capable of sensing various data including external environmental information such as temperature, pressure, humidity, voltage, current, etc., and capable of sensing a status of the sensor 151, may be used. Examples of such sensors are as follows:

i) Simple Sensors: sensors that are factory programmed and are not user configurable and provide a single observation such as a pass/fail indication or a simple measurement of a particular sensor condition,

ii) Full-function Sensors: sensors that may be configured, re-configured or reset by the user and may produce a detailed or comprehensive set of sensor data or observations, and

iii) Full-function Sensors with Simple Sensor function: complex sensors that may be configured to provide a single observation similar to that provided by a Simple Sensor.

The transmitting/receiving unit 153 transmits an access request message or a data request message from the RFID reader 100 to the control unit 155, and transmits a generated response message to the RFID reader 100.

When the control unit 155 receives a request message from the transmitting/receiving unit 153, the control unit 155 generates a control signal S₁ for configuring a status record and generating a response message. The control unit 155 generates a control signal S₂ for scheduling such as a sensing cycle, monitoring, and an alarm, which are of the sensor 151, thereby controlling a measuring operation of the sensor 151.

The memory 157 receives and stores sensor data measured by the sensor 151. The memory 157 stores a unique item identifier (UII) of the item (an object), and status information about each sensor 151. The sensor data and the sensor status information are stored by using a predetermined method such as the method of matching the sensor data and the sensor status information for each sensor 151 and preparing a list of the sensor data and the sensor status information. The sensor status information may be data generated by each sensor 151 which independently measures a status of each sensor 151 according to predetermined conditions, or may be data predicted by each sensor 151 which analyzes, calculates, and combines the measured sensor data.

The message generation unit 159 generates a response message of a frame according to the control signal S₁ of the control unit 155, wherein the response message includes the sensor data and/or the sensor status information. Thus, the response message includes an RFID tag ID and at least one of the sensor data and the sensor status information. The message generation unit 159 receives the control signal S₁ and traces the sensor data and the sensor status information which are stored in the memory 157, thereby obtaining information requested by the RFID reader 100. The sensor status information may be result information generated by each sensor 151 which independently senses the status of each sensor 151, or may be result information predicted by each sensor 151 which analyzes and combines the sensor data measured by each sensor 151. The message generation unit 159 records the obtained sensor data in a following field of a UII field of the RFID tag 150, and records a status record, which is generated based on the sensor status information, in a following field of the following field. The status record may be recorded in a sensor data field together with the sensor data. The status record may be generated based on status information about all or parts of the one or more sensors connected to the RFID tag 150, or may be only based on status information about a specific sensor particularly requested by the RFID reader 100. The status record may include at least one piece of information from among a plurality of pieces of information such as the total number of sensors, an internal port number of the RFID tag 150 of each sensor 151, whether to activate sensor monitoring, whether to activate a sensor alarm function, whether to generate an alarm, a sensor alarm generation condition, a sensor scheduling mode, whether to store a timestamp, a sensor characteristic, and error information. A detailed description for each of the plurality of pieces of information will be described later.

The generated response message is transmitted to the RFID reader 100 via the transmitting/receiving unit 153.

By doing so, the RFID reader 100 may obtain the sensor status information together with requested data, and is thereby capable of recognizing the sensor status without making a separate request, and thus, time and power can be saved.

Hereinafter, various embodiments which create a sensor status record based on the sensor status information will now be described.

Sensor data and sensor status information may be stored in any available memory. In order to provide the means for retrieving memory, a Simple Sensor Data Address (SSD Address) pointing to the start address of the Simple Sensor Data may be used. If a valid SSD Address (greater than 0000ₕ) is provided, it may be stored in the TID (tag identifier) memory (memory bank 10₂) at memory word 24ₕ MSBs (most significant bits) first. The SSD Address may comprise 6 bits reserved for future use (RFU) followed by 2 bits identifying the memory bank (MB) where the SSD is stored, and a 24 bit EBV (Extensible bit vector) specifying the start address of the SSD.

If a simple sensor does not support the SSD Address then the simple sensor may respond to an access of this address with the appropriate error code. The SSD Address is not necessarily required to be factory programmed and can be changed if the tag has more than one sensor and it is decided to support another sensor from a certain time onwards.

The sensor data and the sensor status information which are sensed by each sensor 151 may be added to a response with respect to an ACK command or an access command and transmitted to the RFID reader 100.

Table 1 is an example of a response message of the RFID tag 150, wherein the response message is transmitted in respond to the ACK command of the RFID reader 100.

The RFID tag 150 provides the SSD address and transmits the sensor data and the sensor status information together with the UII.

TABLE 1

| | Response | Response | | |
|---|---|---|---|---|
| # of bits | 21 to 528 | 8 | 16-496 | 16 |
| Description | response to | length | SensorData | CRC-16 |
| | ACK command | | | |

The length may be a word count of SensorData in words of 16 bits, whereas the 3 MSBs may always be zero and are RFU, which implies that only the combinations 0000 0000b to 0001 1111b are valid. The CRC-16 may be calculated for every Response bit of the ACK command received prior to the CRC-16.

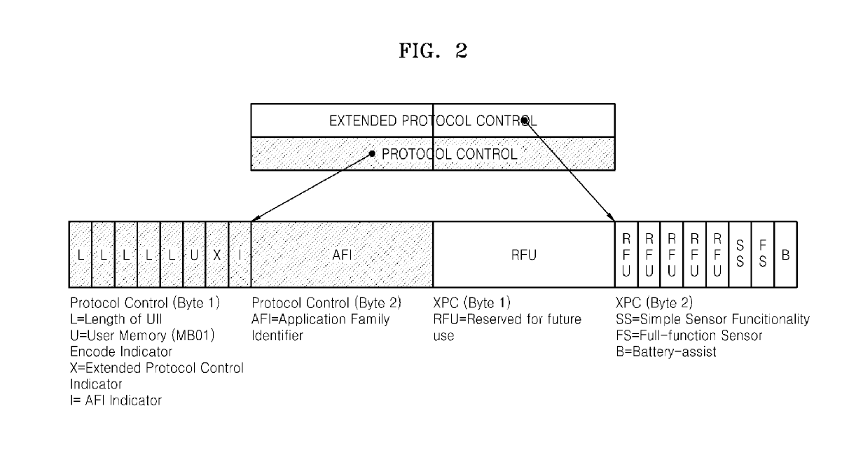

In order to enable the RFID reader 100 to distinguish between the Simple Sensors and the Full Function Sensors, Protocol Control Bit may be used to indicate the presence of eXtended Protocol Control (XPC). The XPC may consist of additional protocol control bits. Referring to FIG. 2, the memory location of the XPC may be arranged so that XPC Bit 3 is B (Battery), XPC Bit 4 is FS (Full Sensor Functionality) and XPC Bit 5 is SS (Simple Sensor Functionality). Within the XPC, the Simple Sensor Functionality Bit (SS) may be used to indicate that the Simple Sensor Data will be subsequently transmitted to the UII by the RFID tag 150 after receiving an ACK command in the course of an inventory round. The SS Bit may be set to 1 if Simple Sensor Data is provided for the tag. Otherwise the SS Bit may be set to 0. If the SS Bit is set, but the FS Bit is cleared, then this indicates that the sensor 151 does not support full sensor functionality and therefore cannot be accessed in any other way. If Simple Sensor Data is supported, then the RFID tag 150 may transmit the Simple Sensor Data following the other content of the UII memory when responding to the ACK command.

The sensor status information may be recorded in the sensor data field together with the sensor data and then transmitted, or may be recorded in a sensor status information field following the sensor data field and then transmitted. In this case, information about the length of the sensor data and information about the length of the sensor status information may be recorded together in a length field.

Table 2 is an example of a response message of the RFID tag 150, wherein the response message is transmitted in respond to the access command (that is, a sensor status read command) of the RFID reader 100.

TABLE 2

| | | Sensor Status | | |
|---|---|---|---|---|
| | Header | Record | RN | CRC-16 |
| # of bits | 1 | variable | 16 | 16 |
| Description | 0 | Data | handle | |

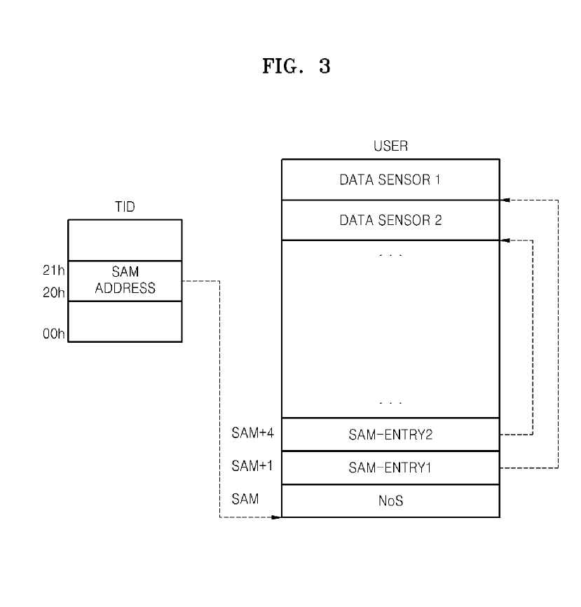

Sensor access is handled via a fixed address for tracing sensor information and mapped memory positions via a sensor address map (SAM). The SAM address may be stored in the TID memory (memory bank 10₂) at memory word 20 h MSBs first. The SAM Address may comprise 6 bits reserved for future use (RFU) followed by 2 bits identifying the memory bank (MB) where the SAM is stored, and a 24 bit EBV specifying the start address of the SAM. The default value for the SAM Address may be 0 to indicate no sensor. A battery assisted RFID tags 150 with one or more sensors 151 may have a SAM Address≠0. The SAM contains the memory address and information on the range of each sensor 151 and allows port type access to sensor configuration records and sensor data through the use of access commands Read, Write, and BlockWrite. The structure of the SAM comprises the number of available sensors (NoS), and a single SAM-Entry may consist of 6 bits reserved for future use (RFU), the memory bank (MB), a EBV specifying the memory address inside the denoted memory bank, and a EBV specifying the memory range occupied by the sensor. A SAM and sensor data (configuration data+measurement data) may be stored in the same MB, e.g. extending in opposite directions as illustrated in FIG. 3.

Sensor access commands allow the RFID reader 100 to access the one or more sensors 151 attached to the RFID tag 150 and to read and write sensor specific data, and do not define sizes of memory areas, for example, areas for measurement data storage. Hence, records and fields may be stored at different memory locations in different RFID tags. The sensor access commands programmatically allow the RFID reader 100 to read and write sensor specific data without the need to determine memory locations for specific fields or records.

When the RFID reader 100 accesses, the RFID tag 150 may provide the RFID tag ID together with status information about a specific sensor, as illustrated in Table 2. Referring to Table 2, the response message of the RFID tag 150 includes a header indicating whether the RFID tag 150 has succeeded in carrying out a command, a sensor status record, a handle of the RFID tag 150 and CRC-16 which is calculated for a bit from the header to the handle. The RFID tag 150 may transmit the sensor data together with the sensor status record of Table 2 in respond to a specific sensor data request command from the RFID reader 100, without separately receiving a sensor status read command.

Table 3 shows a structure of the sensor status information to be transmitted together with an existing ID, according to an embodiment of the present invention.

Table 3 illustrates a sensor status block that is attached to ISO18000-6AM1 [ISO18000-6AM1] based on the UII block in the apparatus for transmitting the sensor status of the RFID tag according to the current embodiment. The sensor status block includes a summary of a current status of each sensor 151.

Referring to Table 3, the sensor status information (Sensor Status Block+CRC16) is added in the back of existing UII information (PC+UII+CRC16) and transmitted. At this point, the sensor status information is transmitted together with information regarding the total number of sensors that exist on the RFID tag 150.

TABLE 3

| | | | Sensor status | |
|---|---|---|---|---|
| PC | UII | CRC16 | block | CRC16 |
| 8 | 16 . . . 512 | 16 | 16 + NoS*12 | 16 |

Table 4 is an example illustrating the sensor status block of Table 3 in detail. The first 16 bits represent the total number of sensors embedded in the RFID tag 150. Then, 12 bits are allocated to the sensor status information for each sensor 151. A status record of each sensor 151 follows the number of sensors based on a value of a data field of the number of sensors NoS.

TABLE 4

| Number of Sensors | Sensor status sensor 1 | Sensor status sensor 2 | . . . |
|---|---|---|---|
| 16 | 12 | 12 | 12 |

Table 5 is an example illustrating a detailed structure of the sensor status record for each sensor 151. The most important information regarding each sensor 151 is summarized in the table.

Referring to Table 5, the first seven bits represent a port number of one of the sensors 151 in the RFID tag 150. The next one bit (the eighth bit) records whether each sensor 151 has started monitoring. The next one bit (the ninth bit) records whether an alarm has been activated. When the alarm is generated due to activation, the next two bits (the tenth and eleventh bits) record an alarm generation condition (see Table 6). Generating the alarm is determined according to whether a data value measured by each sensor 151 deviates from a reference value. An alarm generation condition field determines whether the sensed data value is within an effective range or whether the sensed data value deviates from a predetermined reference value, by comparing the sensed data value with the reference value (an upper limit threshold value or a lower limit threshold value). The next one bit (the twelfth bit) records whether an error occurs in the sensor 151, such as when the sensor 151 cannot sense the item or when the sensor is broken.

TABLE 5

| Parameter | Description |
|---|---|
| Tag internal sensor port | Tag internal sensor port number assigned |
| number [7 Bit] | like described in the planned ISO/IEC24573 |
| Sensor monitoring activated | Sensor monitoring activated? high |
| [1 Bit] | (activated)/low (not activated) |
| Sensor alarm handling | Sensor alarm handling activated? high |
| activated [1 Bit] | (activated)/low (not activated) |
| Sensor data alarm [2 Bit] | See Table 6 |
| Sensor error [1 Bit] | There was an error handling this sensor |
| | (high (yes)/low (no)) |

When the activation of the alarm in the sensor 151 is set in Table 5, Table 6 illustrates an example of sensor alarm status information which is set by two bits. The sensor alarm status information is designed so that it is possible to know that an alarm has been generated when the data value of each sensor 151 deviates from the upper limit threshold value or the lower limit threshold value, thereby being excluded from the effective range.

TABLE 6

| Value | Sensor data alarm? |
|---|---|
| 00 | No alarm |
| 01 | Yes, value above upper boundary |
| 10 | Yes, value below lower boundary |
| 11 | Other alarm |

Table 7 illustrates a structure of a sensor status record according to another embodiment of the present invention.

The sensor status record describes a summary of information, which describes an actual status of the sensor 151. The sensor status record may be stored in the memory 157 of the RFID tag 150, or may be computed by the application running on the RFID tag 150 after a related request is made by the RFID reader 100. At least 24 bits may be used according to a length of an EBV.

TABLE 7

| Alarm raised by this | | Number of saved | |
|---|---|---|---|
| sensor? | Error code | sensor values | RFU |
| 2 bits | 8 bits | EBV | 6 bits |

Table 8 illustrates an example for describing in detail a parameter ‘Alarm raised by this sensor?’ of Table 7.

Table 8 shows the related sensor which has caused an alarm to go off. In addition, Table 8 contains information indicating which limit has been crossed.

TABLE 8

| Value | Alarm raised by this sensor? |
|---|---|
| 00 | No alarm |
| 01 | Yes, upper alarm condition |
| 10 | Yes, lower alarm condition |
| 11 | reserved |

Table 9 illustrates an example for describing in detail a parameter ‘Number of saved sensor values?’ of Table 7. The parameter represents the number of sensor values stored in the memory 157 related to each sensor 151.

TABLE 9

| Value | Number of saved sensor values |
|---|---|
| EBV | The number of sensor values, which have been |
| | saved in the memory area related to the sensor |

Table 10 illustrates a configuration of a sensor status record including a sensor scheduling mode according to another embodiment of the present invention. 48 bits or 80 bits may be used according to an accuracy of sensor data.

TABLE 10

| Sensor | Timestamp | | | Alarm | Upper | Lower | |
|---|---|---|---|---|---|---|---|
| monitoring | saved with | Scheduling | Alarm | raised by | alarm | alarm | |
| activated | sensor data? | modee | activated? | this sensor? | value | value | RFU |
| 1 bit | 1 bit | 2 bits | 1 bit | 2 bits | 16 bits/ | 16 bits/ | 9 bits |
| | | | | | 32 bits | 32 bits | |

Table 11 illustrates an example for describing in detail the parameter ‘Sensor monitoring activated’ of Table 10. The parameter defines activation of the sensor monitoring. For example, if the status bit is set to zero, the monitoring will not be started independently from the configuration values set. Depending on the scheduling mode or the start time setting the monitoring is started immediately or at a defined time.

TABLE 11

| Value | Sensor monitoring activated |
|---|---|
| 0/1 | Yes/No - activates the monitoring of the sensor |

Table 12 illustrates an example for describing in detail a parameter ‘Timestamp saved with sensor data?’ of Table 10. The parameter defines whether the related timestamp is saved together with each sensor data or not. An additional 32 bit memory for each sensor value is required in order to save the timestamp for each sensor data.

TABLE 12

| Value | Timestamp saved with sensor data? |
|---|---|
| 0/1 | Yes/No - defines whether the timestamp will be saved together |
| | with the sensor data (requires more memory) or not |

Table 13 illustrates an example for describing in detail a parameter ‘Scheduling mode’ of Table 10. The parameter may include a configuration for adjusting an alarm so as to define a scheduling mode for reading the sensor 151.

There are three different types of values defined: i) a short time cyclic reading with a repeat time shorter than a day, ii) a specified long time cyclic reading with a repeat cycle of more than one day and iii) the reading of the sensor regarding an alarm condition only. The first method (the short time cyclic reading) is easy to configure and will fulfil most application requirements. The second method allows setting of a specific time and date for the measurement as well as a long time repeat cycle.

TABLE 13

| Value | Scheduling mode |
|---|---|
| 00 | Short time cyclic (<1 day repeat) |
| 01 | Specified long time cyclic (>1 day repeat) |
| 10 | Alarm condition only (requires sensor data |
| | format including timestamp) |
| 11 | reserved |

‘Short time cyclic’ is a scheduling mode which is intended for short time cyclic reading of the sensor 151. The repeat time should be shorter than one day. Typical values are several minutes/seconds or hours. An example of this is supply chain tracking of frozen cargo. General applications require reading of the temperature sensor every 30 minutes. In addition, if an alarm goes off, the alarm raising value is also recorded.

‘Specified long time cyclic’ is a scheduling mode which is intended for long time measurements with a repeat time of more than 1 day. This method may be used for short time measurements at specific times too, as the exact time of each measurement can be defined. For example, in vibration sensing of a bridge, the highest vibration is caused by the largest traffic load on the bridge, which requires monitoring during rush hour traffic, and thus, an exact time of the measurement has to be defined.

‘Alarm condition only’ is a scheduling mode which allows recording data only when an alarm condition has occurred, which means the upper or lower value has been crossed. This requires that the sensor data format including the timestamp is used to save the data. An example of this is when a smoke detector mounted in a building makes an alarm go off if a certain level of smoke intensity is crossed.

Table 14 illustrates an example for describing in detail the parameter ‘Alarm activated’ of Table 10. The parameter defines whether the monitoring of the alarm conditions has been activated or not by the RFID tag 150. If the status bit is set to zero, no alarm will go off even when the value crosses a defined limit.

TABLE 14

| Value | Alarm activated? |
|---|---|
| 0/1 | Yes/no ?activates the monitoring of the alarm conditions |

Table 15 illustrates an example for describing in detail a parameter ‘Alarm raised by this sensor?’ of Table 10. Table 15 shows two status bits for indicating if the related sensor caused an alarm to go off. In addition, Table 15 contains the information which limit has been crossed.

TABLE 15

| Value | Alarm raised by this sensor? |
|---|---|
| 00 | No alarm |
| 01 | Yes, upper alarm condition |
| 10 | Yes, lower alarm condition |
| 11 | reserved |

Table 16 illustrates an example for describing in detail the parameters ‘upper alarm condition’ and ‘lower alarm condition’, of Table 10. The ‘upper alarm condition’ and the ‘lower alarm condition’ define a threshold level and operate according to an alarm condition when alarm monitoring is activated.

TABLE 16

| Value | Alarm value |
|---|---|
| 16 bit/32 bit | First alarm threshold value |
| 16 bit/32 bit | Second alarm threshold value |

As described above, the sensor status information having various parameters and formats may be generated together with the RFID tag ID by the RFID tag 150, and is therefore provided to the RFID reader 100.

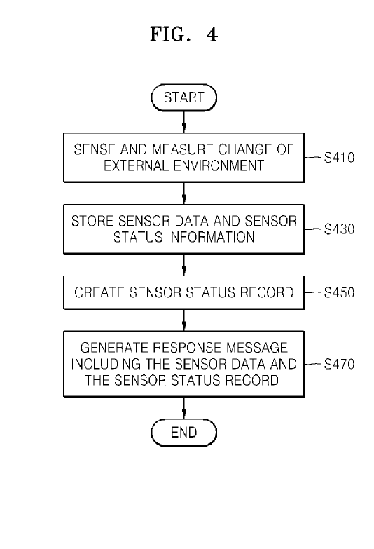

FIG. 4 is a flowchart of a method of transmitting a sensor status of an RFID tag, according to an embodiment of the present invention. Detailed descriptions, which are the same as the aforementioned contents, will be omitted.

Referring to FIG. 4, an apparatus for transmitting the sensor status of the RFID tag senses and measures a physical change of an item (an object) (operation S410).

Measured sensor data and sensor status information are stored in a memory (of the RFID tag (operation S430). The memory includes a UII of the item.

In the case where an RFID reader accesses the RFID tag and requests an ACK command or sensor data, a sensor status record is generated based on the sensor status information stored in the memory (operation S450). According to the request from the RFID reader, the sensor status record may be generated with status information about all or parts of the one or more sensors, or status information about a specific sensor. The sensor status record may include at least one piece of information from among a plurality pieces of information about such as the number of sensors, an internal port number of the RFID tag of the sensor, whether to activate a sensor monitoring, whether to activate a sensor alarm function, whether to generate an alarm, a sensor alarm generation condition, whether to store timestamp, a scheduling mode, a sensor characteristic, and error information. The sensor alarm generation condition may include whether a value of the sensor data deviates from an upper limit threshold value or a lower limit threshold value. The scheduling mode may be information indicating a measurement condition of the sensor. The measurement condition may include a measurement cycle. In addition to the aforementioned examples, various parameters capable of indicating the sensor status may be set and measured so as to be provided.

A response message including fields of the UII of the RFID tag, the sensor data, and the sensor status record generated based on the sensor status information is generated and transmitted to the RFID reader (operation S470).

By doing so, the RFID reader does not need to additionally communicate with the RFID tag so as to obtain the sensor status information.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to embodiments thereof, it will be understood by those of ordinary skill in the art that various changes in form and details may be made therein without departing from the spirit and scope of the invention as defined by the appended claims. The embodiments should be considered in a descriptive sense only and not for purposes of limitation. Therefore, the scope of the invention is defined not by the detailed description of the invention but by the appended claims, and all differences within the scope will be construed as being included in the present invention.

1. An apparatus for transmitting a sensor status of an RFID (radio frequency identification) tag, the apparatus comprising:
one or more sensors sensing and measuring a physical change in an external environment;
a memory storing sensor data and sensor status information which are measured by the one or more sensors; and
a message generation unit generating a response message comprising an RFID tag ID (identifier), and at least one of a status record generated based on the sensor status information and the sensor data.

2. The apparatus of claim 1, wherein the status record is generated with status information about all or parts of the one or more sensors, or status information about a specific sensor, according to a request of an RFID reader.

3. The apparatus of claim 1, wherein the status record comprises at least one piece of information from among a plurality pieces of information about the number of sensors, an internal port number of the RFID tag of a sensor, whether to activate sensor monitoring, whether to activate a sensor alarm function, whether to generate an alarm, a sensor alarm generation condition, whether to store a timestamp, a scheduling mode, a sensor characteristic, and error information.

4. The apparatus of claim 3, wherein the sensor alarm generation condition comprises whether a measured data value deviates from an upper limit threshold value or a lower limit threshold value.

5. The apparatus of claim 3, wherein the scheduling mode comprises a measurement cycle of the one or more sensors.

6. The apparatus of claim 1, further comprising a control unit generating a control signal for controlling a measuring operation of the one or more sensors and generating the status record.

7. A method of transmitting a sensor status of an RFID tag, the method comprising:
sensing a physical change in an external environment from one or more sensors which are connected the RFID tag and storing sensor data and sensor status information measured by the one or more sensors;
generating a status record based on the sensor status information about the one or more sensors; and
generating a response message comprising an RFID tag ID, and at least one of the status record generated based on the sensor status information and the sensor data.

8. The method of claim 7, wherein the status record is created with status information about all or parts of the one or more sensors, or status information about a specific sensor, according to a request of an RFID reader.

9. The method of claim 7, wherein the status record comprises at least one piece of information from among a plurality pieces of information about the number of sensors, an internal port number of the RFID tag of a sensor, whether to activate sensor monitoring, whether to activate a sensor alarm function, whether to generate an alarm, a sensor alarm generation condition, whether to store a timestamp, a scheduling mode, a sensor characteristic, and error information.

10. The method of claim 9, wherein the sensor alarm generation condition comprises whether a measured data value deviates from an upper limit threshold value or a lower limit threshold value.

11. The method of claim 9, wherein the scheduling mode comprises a measurement cycle of the one or more sensors.

12. A method of generating a response message with respect to a sensor data request from an RFID reader by an RFID tag, the method comprising:
recording a UII (unique item identifier) of the RFID tag;
recording sensor data gathered from one or more sensors which have measured a physical change in an external item; and
recording status information about each of the one or more sensors.
